(19) United States
(12) Patent Application Publication
(10) Pub. No.: US 2014/0007353 A1
(43) Pub. Date: Jan. 9, 2014

(54) PATIENT TURNER

(71) Applicants: Martin W. Stryker, Kalamazoo, MI (US); Sean Stephen Daugherty, Brookfield, WI (US); Jason James Wroblewski, Kalamazoo, MI (US)

(72) Inventors: Martin W. Stryker, Kalamazoo, MI (US); Sean Stephen Daugherty, Brookfield, WI (US); Jason James Wroblewski, Kalamazoo, MI (US)

(73) Assignee: STRYKER CORPORATION, Kalamazoo, MI (US)

(21) Appl. No.: 13/873,847

(22) Filed: Apr. 30, 2013

Related U.S. Application Data
(60) Provisional application No. 61/640,283, filed on Apr. 30, 2012.

(51) Int. Cl. A61G 7/00

(52) U.S. Cl. CPC A61G 7/001
USPC 5/715

(57) ABSTRACT

A patient turner for positioning on a mattress includes a base layer and a turning bladder layer, with the turning bladder layer being configured for positioning either immediately under the patient or under a non-supporting layer, which is immediately under the patient, and with the base layer supporting the turning bladder above the mattress.

The present application claims the benefit of U.S. provisional application Ser. No. 61/640,283, entitled Patient Turner, filed Apr. 30, 2012, which is hereby incorporated by reference in its entirety herein.

### TECHNICAL FIELD AND BACKGROUND OF THE INVENTION

The present invention generally relates to a turning surface for turning a patient.

The pressure at the interface between a patient and a support surface, such as a mattress, on which the patient is supported can significantly affect the well-being of the patient, especially an immobile patient or heavier patient, because a high interface pressures can reduce local blood circulation, increase the risk of forming bed sores and/or cause other medical complications.

While many support surfaces, such as mattresses, are configured to redistribute pressure at the interface with a patient to reduce the interface pressure, turning bladders play an important role, for example on mattresses, in further reducing the pressure on a patient's skin by simply shifting the applied pressure from one side of the patient to another side of the patient.

Typically, turning bladders are located under the mattress or primary patient support surface. However, in order to turn the patient, the turning bladder must fold the overlying mattress. As a result, the control over the patient turning can be somewhat hampered by the mattress's resistance to folding, which, when in the form of an inflatable mattress, can vary along the length due to the variable pressures in the individual bladders forming the support surface.

More recently, a mattress has been developed in which the turning bladders form the primary support surface, such as disclosed in U.S. patent application entitled RESILIENT MATERIAL/AIR BLADDER SYSTEM, Ser. No. 12/234,818, filed Sep. 22, 2008 (Attorney Docket No. STR03 P307), which is commonly assigned to Stryker Corporation of Kalamazoo, Mich. and is hereby incorporated by reference herein in its entirety. However, the turning bladders may be subject to unintended repositioning or stress when a patient is transferred off the mattress or pulled up to the head end of the mattress by patient repositioners, especially when the patient is heavy.

Accordingly, there is a continuing need for surfaces that can help assist in reducing the interface pressure between a patient and the mattress on which the patient is supported while still providing a full range of functionality.

### SUMMARY OF THE INVENTION

The present invention provides a turning surface to roll a patient from one side to another side, which can help assist in reducing the interface pressure between a patient and the patient support on which the patient is supported. The turning surface provides improved the control over the turning of the patient and more closely mimics the conventional practice of placing pillows under a patient, which normally requires manual lifting of the patient. The present invention may also provide a turning surface with a low air loss function that can overlay, for example, a mattress, so that the surface can increase the functionality of the mattress. Further, the functionality of the surface may be selectively operated by a patient or a caregiver.

In one form of the invention, an overlay for a mattress that is configured to turn a patient supported thereon includes a turning bladder layer. The turning bladder layer is configured for positioning either immediately under the patient or under a non-supporting layer, which is immediately under the patient. Thus, the turning bladders either contact or are in close proximity to the patient's body, which improves control over the turning of the patient. Alternately, the turning bladder layer may be positioned under a support surface, such as a mattress.

In one aspect, the turning bladder layer is supported on a base layer.

In another aspect, the base layer includes a relief area for the sacral region of a patient. In a further aspect, the base layer may also include relief areas for the trochanter regions of the patient. For example, the relief areas may comprise areas or reduced thickness or transverse openings that extend through the base layer from its upper surface through to its lower surface. Alternately, the relief areas may be formed from materials that are “softer” or more resilient.

In a further aspect, any of the above overlays may include a low air loss layer. In one embodiment, the turning bladder layer forms the low air loss layer. In another embodiment, the low air loss layer is separate layer, which overlays the turning bladder layer.

In yet further aspects, each of the layers of the overlay is in fluid communication with an air supply.

In another form of the invention, a patient turner includes a turning bladder layer. The bladder layer includes at least a left side bladder and a right side bladder. The bladder layer also includes at least one relief area where there is no inflation even when one or both of the left side bladder and the right side bladder are inflated.

For example, the relief area may comprise a heel relief area.

The bladder layer may include other relief areas, such as for the sacral region of a patient and/or trochanter regions of the patient.

In another form of the invention, a patient turner includes a turning bladder layer. The bladder layer includes at least a left side bladder and a right side bladder. The bladder layer also includes a central longitudinal axis. Each bladder forms a chamber, and with each chamber having at least one region with a reduced cross-section to reduce the volume of the respective chamber at that region.

In any of the above patient turners, the turning bladder layer may be configured for positioning either immediately under the patient or under a non-supporting layer, which is immediately under the patient. Thus, the turning bladders either contact or are in close proximity to the patient's body, which improves control over the turning of the patient.

Alternately, any of the above patient turners may be configured for placement under a mattress to retrofit an existing mattress that does not have turning devices or bladders.

In any of the above patient turners, the turning bladder layer may be supported on a base layer, with the base layer including a relief area for the heels or sacral region of a patient or the trochanter regions of the patient.

In a further aspect, any of the above patient turners may include a low air loss layer. In one embodiment, the turning bladder layer forms the low air loss layer. In another embodiment, the low air loss layer is separate layer, which overlays the turning bladder layer.

In yet further aspects, in any of the layers, the layers may be in fluid communication with an air supply.

These and other objects, advantages, purposes, and features of the invention will become more apparent from the study of the following description taken in conjunction with the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### DESCRIPTION OF THE FIGURES

FIG. 1 is a perspective view of the patient turner of the present invention;

FIG. 2 is a top plan view of the top layer of the patient turner of FIG. 1;

FIG. 3 is a perspective view of the patient turner with the top layer removed to show the intermediate layer, which comprises a turning bladder layer;

FIG. 4 is an end elevation view of the patient turner with the top layer removed;

FIG. 5 is an enlarged view illustrating the turning axis of the intermediate layer;

FIG. 6 is a perspective view with the top layer removed illustrating the turning bladders inflated;

FIG. 7 is a similar view to FIG. 6 with the left side turning bladder inflated and the right side turning bladder deflated;

FIG. 8 is a similar view to FIG. 7 with the right side bladder removed to show the cushioning bottom layer;

FIG. 9 is a top plan view of the intermediate layer;

FIG. 10 is a perspective view of the cushioning layer with the intermediate layer and top layer removed for clarity;

FIG. 11 is a top plan view of the cushioning layer shown in a deflated state;

FIG. 12 is a perspective view of another embodiment of the patient turner of the present invention;

FIG. 13 is yet another embodiment of the patient turner of the present invention;

FIG. 14 is a perspective view of the patient turner of FIG. 13 illustrated in use on a patient support, such as a hospital bed;

FIG. 15 is an enlarged perspective view of the head end of the patient turner of FIG. 13;

FIG. 16 is an end view illustrating a patient being turned to the left on the patient turner as viewed from the head end of patient turner;

FIG. 17 is a similar view to FIG. 16 illustrating the patient being turned to the right as viewed from the head end of patient turner;

FIG. 18 is a perspective view of a dispenser for dispensing a patient turner of the present invention;

FIG. 19 is a plan view of another embodiment of the patient turner of the present invention; and

FIG. 20 is a perspective view of the patient turner of FIG. 19 illustrating one of the bladders in an inflated state.

### DETAILED DESCRIPTION OF THE PREFERRED EMBODIMENTS

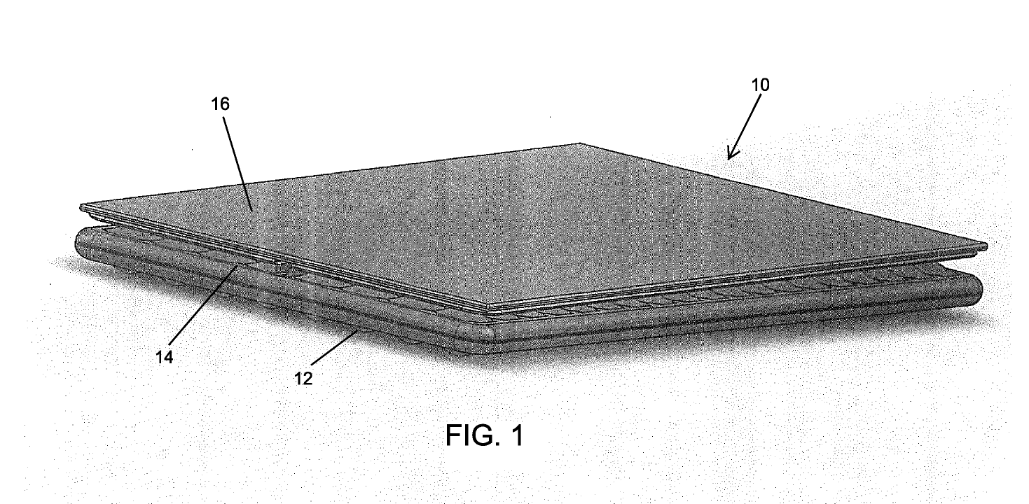

Referring to FIG. 1, the numeral 10 generally designates one embodiment of a patient turner in the form of an overlay of the present invention, which is particularly useful when handling heavier patients. As will be more fully described below, patient turner 10 may be configured for positioning on top of patient support surface, such as a mattress, on a bed, such as a hospital bed, long term care bed, or a home care bed, and incorporates two or more turning bladders to selectively turn the patient in a manner that closely mimics pillows placed under the patient to assist in reducing the local pressure on a patient's skin lying on the turning surface and also to reduce the stress on a caregiver. Further, patient turner 10 is optionally configured to selectively provide a low air loss surface to reduce, if not prevent, moisture build up at the patient interface when a patient is supported on the patient turner.

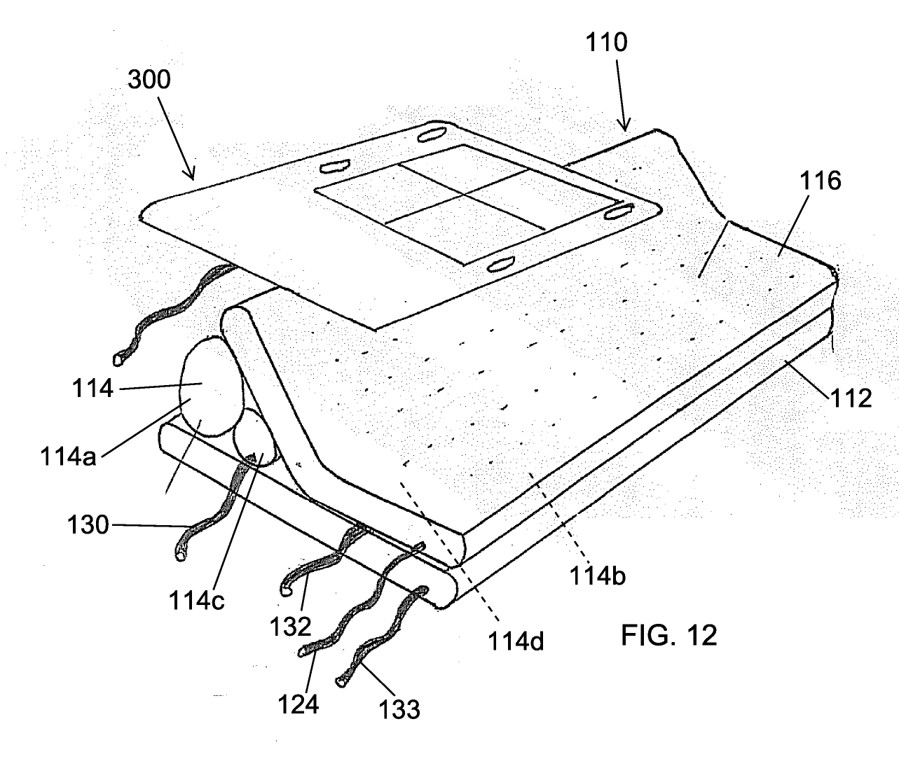

As best seen in FIG. 1, patient turner 10 includes a base layer 12, an intermediate layer 14, and an optional top layer 16, which may be configured as a low air loss surface. Base layer 12 optionally comprises a cushioning layer, with intermediate layer 14 comprising two or more turning bladders to turn a patient supported on the top layer 16 about a longitudinal axis of the surface so that a patient may be turned from their left side to their right side to reduce pressure points on the patient's skin. The patient turner 10 is configured for positioning either under a non-supporting layer, which is immediately under the patient, or immediately under the patient (as shown in FIG. 12). Thus, the turning bladders may either contact or are in close proximity to the patient's body, and optionally without any supporting cushioning layers in between, which improves control over the turning of the patient. In other words, while the bladders may have a layer between them and the patient, the intermediate layer or layers do not suspend the patient above the bladders or provide any significant support or pressure redistribution, for example, that would be associated with a mattress, and instead simply at most provide an air flow space that is isolated from (to avoid contamination) and above the bladders. Alternately, an intermediate cushioning layer or supporting layer may be interposed between the patient and the patient turner so that that bladder layer is spaced from the patient. Further, the intermediate cushioning layer may be configured to provide pressure redistribution, such as a mattress, and therefore can be used to retrofit mattresses or beds that do not currently have patient turning devices.

Referring to FIG. 3, top layer 16 may be formed from upper and lower sheets 18, 20 that are sealed together around their respective perimeters, for example, by heat sealing, RF sealing, sonic welding, or the like. Furthermore, the seal may be reinforced by stitching. Optionally, the sheets (18, 20) may be tied together (e.g. by spot welds or ties that are welded to the respective sheets) at intermediate locations between their perimeters to avoid lofting and creating a hammock effect. Upper sheet 18 may be formed from a non-permeable plastic material, such as a “skin friendly” material such as TYVEC, which is non-permeable but provides a cloth like texture at its upwardly facing surface to provide a comfortable feel to the patient supported therein. Alternately, the upper sheet 18 may be formed from two or more materials, one comprising a cotton-like material, which is joined or coated with an impermeable layer to create the non-permeable sheet. For example, the inwardly facing layer of the upper sheet may be joined or coated with an impermeable layer or material. Lower sheet 20 may be formed from a non-permeable polymeric material, such vinyl, polyethylene, polyurethane or combinations thereof. Similarly, lower sheet 20 may be formed from two or more materials to create the non-permeable sheet.

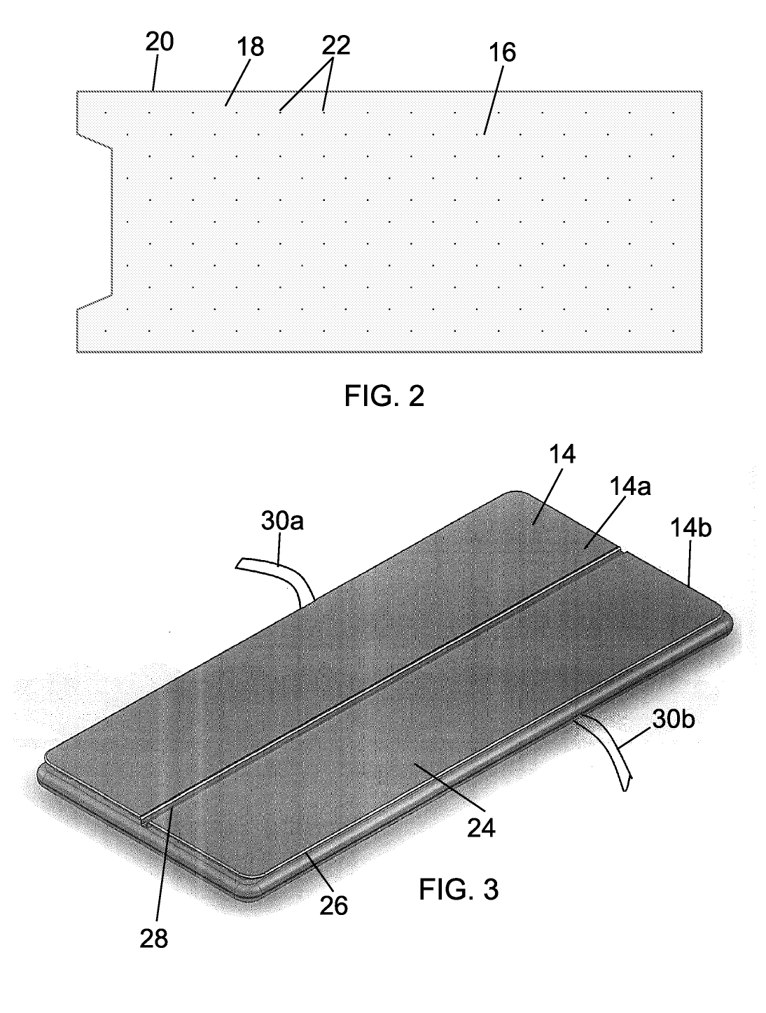

Again referring to FIG. 2, upper sheet 18 may also include a plurality of apertures 22, which may be provided across the full length and width of the upper sheet or may be concentrated in one or more desired locations, such as one or more target regions of the patient, such as the sacral region. Further, the apertures may be uniformly spaced or have regions with varied spacing to provide a higher or lower concentration of apertures. Air is delivered layer 16 by way of at least one inlet/outlet, which is coupled to a conduit 24, such as conventional tubing or a lumen of a multi-lumen conduit, which in turn is coupled to an air supply, such as a pump, fan, or compressor. For further details of the location and options for the air supply, reference is made to the description that follows below.

Alternately, upper sheet 18 may be formed from material that has interstices that allow air to flow through the upper surface (and thereby provide the low air loss function) but which are small enough to limit liquid intrusion into layer 18 and also reduce the air loss. For examples of suitable materials reference is made to the patient transfer pad described in U.S. patent application entitled PATIENT TRANSFER DEVICE, Ser. No. 12/554,431, filed Sep. 4, 2009 (Attorney Docket No. STR03C P241), which is commonly assigned to Stryker Corporation of Kalamazoo, Mich. and hereby incorporated by reference herein its entirety.

In yet another embodiment, the top layer 16 may be formed as a microclimate management layer in the form of a single layer or system of layers, which allow moisture to flow into the layer to draw moisture, away from the patient's skin but which optionally prevents the moisture from flowing into the bladders below. The top layer 16 may also control the temperature, e.g. remove heat to make the body cooler or add heat to make the body warmer. For example, the layer may be configured as a cover, with the cover formed from a material that allows moisture to pass through the cover but which does not allow viruses or bacteria to pass through. In this manner, the main component of the support, namely the bladders, may be reused without risk of contamination from a patient or the environment, and optionally recovered with a reconditioned or new cover.

In one form, the top layer may include a generally moisture vapor permeable upper layer, a lofting layer and a liquid impermeable lower layer. The top layer may also include an inlet in fluid communication with the space between the upper and lower layers for directing gas flow between the moisture vapor permeable upper layer and the liquid impermeable lower layer, and a fluid supply device in fluid communication with the inlet for directing fluid through the inlet. For example, the moisture vapor permeable layer may be constructed from a hydrophilic material, which provides the barrier to microorganisms characteristic noted above. For further details, reference is made to copending provisional application 61/778,828, filed Mar. 13, 2013, entitled PATIENT SUPPORT WITH MICROCLIMATE MANAGEMENT SYSTEM, which is incorporated by reference herein in its entirety.

As noted above, upper layer 16 is supported on intermediate layer 14, which comprises two more turning bladders. As best seen in FIG. 3, intermediate layer 14 forms at least two bladders, namely a left side bladder 14a and a right side bladder 14b. Bladders 14a and 14b may be formed by an upper sheet 24 and a lower sheet 26, which are sealed together at their respective perimeters and, further, along the central portion of the layer to form a central seam 28, which divides the plenum between the respective upper and lower sheets 24 and 26 into two separate plenums to form the turning bladders. For example, the sheets forming the bladder may be a polymeric material, for example, vinyl, polyethylene, polyurethane or combinations thereof. The bladders can be made from a single piece of material or a plurality of materials or a plurality of pieces of material to obtain the desired results.

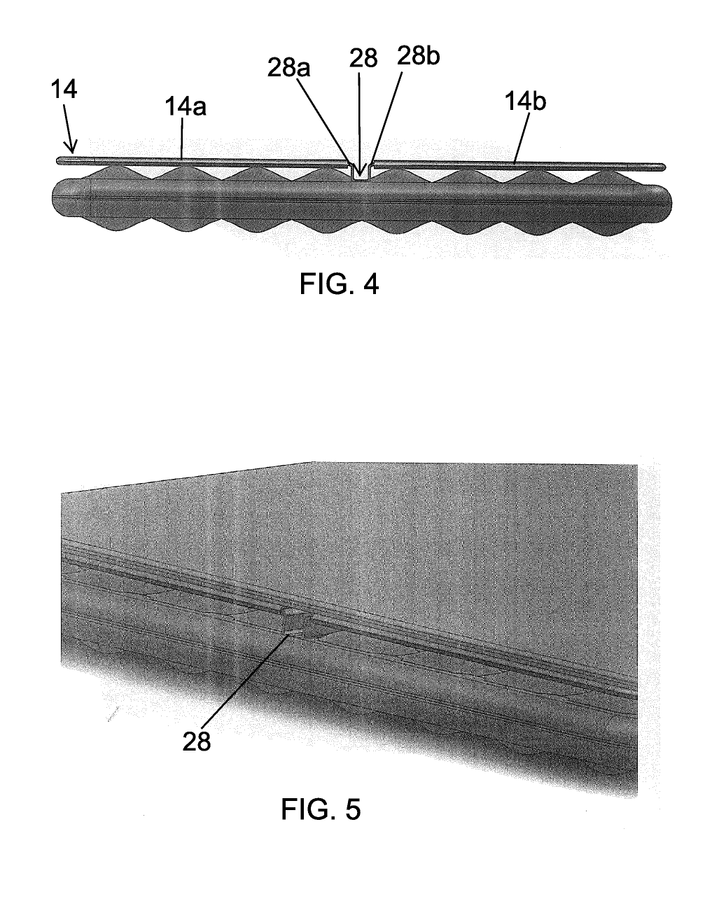

The central seam 28 may be formed by a single weld or multiple welds that secure the upper and lower sheets together to form a central hinge for the respective turning bladders. As best seen in FIGS. 4 and 5, seam 28 may be formed from two or more spaced apart generally parallel welds 28a and 28b so that the hinge can extend into the space between adjacent bladders or pockets of the bottom layer, described more full below, and, moreover, will provide some slack between the bladders to reduce the pressure on the hinge when a bladder is inflated. Similarly, fluid, typically air, is supplied to and optionally evacuated from the respective bladders by one or more inlets/outlets, which are coupled to respective conduits 30a, 30b, such as tubing, which are connected to either the same or different air supply that supplies air to low air loss surface 16. Again, conduits 30a, 30b may replaced by a single conduit with multiple lumens.

The fluid flowing to the bladders through the conduit(s) may have its fluid flow, flow rate, and temperature (as will be more fully described below) and other characteristics optionally controlled by a control unit separate from the bed or by a bed-based controller and fluid supply system, such as described in U.S. patent application entitled PATIENT SUPPORT WITH UNIVERSAL ENERGY SUPPLY SYSTEM, Ser. No. 12/057,941, filed Mar. 28, 2008 (Attorney Docket No. STR03 P106A), which is commonly assigned to Stryker Corporation of Kalamazoo, Mich., which is hereby incorporated by reference in its entirety,

The control unit, for example, may include a user interface device (e.g. keypad or touch screen) interconnected to a controller, such as a microprocessor, which allows a patient or patient's caregiver to control the fluid characteristics of the fluid flowing through the patient turner. The term user interface device is used broadly and includes a touch screen, a remote hand held device, for example with input keys or buttons, a keyboard, switches, a voice activation system, levers, dials or any other conventional user interface device that can be used as an input device by a patient or patient's caregiver to control the operation of the fluid characteristics. For example, the user interface device may be configured to allow a patient or caregiver to select one or more functions, such as the turn function, low air loss, and/or warming/cooling function. Thus, depending on the condition of the patient, the turn function may be selected, while the low air loss function is not—and vice versa, the low air loss function may be selected and the turn function not.

Additionally, patient turner 10 may incorporate one or more sensors, for example, to detect moisture or wetness, for example wetness associated with an incontinence episode, to detect temperature, pressure, or activity or lack of activity. A sensor to detect the number of turns may also be incorporated to track a treatment protocol. Suitable sensors include a switch, a capacitor based sensor, an inductive based sensor, a piezoresistive sensor or pieziometer based sensor, which may be in communication with the control unit or bed-based controller.

In the microprocessor embodiment, the microprocessor receives the desired instructions from the user interface device. From those instructions, the microprocessor processes those instructions to transmit the desired signals to operate the pump, fan or compressor, a heater or cooler, such as a Peltier effect device, a fan, valves and/or switches that push, pull and/or allows (by potential energy contained in the bladder(s)) a fluid to flow into, through or to pass into a first conduit(s) to the respective bladder(s) with the desired fluid characteristics. Prior to entering the pump, compressor or fan, the fluid may be contained within a temperature controlled reservoir or the ambient environment and/or combinations thereof.

Additionally, the control system may generate a desired fluid flow pattern within the bladder. To obtain such results and others like it, the bladders could have predetermined button seals or welds, seals or welds, and slits along seals or welds. Further, as will be more fully described below in reference to FIGS. 12-14, each of the left and right turn bladders may be divided or segmented. For example, the left side bladder may be divided to form, for example: a head-end, left side bladder, a foot-end, left side bladder, and a seat, left side bladder. Similarly, the right side bladder may be divided to form, a head-end, right side bladder, a foot-end, right side bladder, a seat, right side bladder. Thus, the bladders may also be configured to wave therapy.

The turning bladders rotate a patient positioned on the surface bladder by controlling the air pressure in the right turning bladder(s) and the left turning bladder(s). For example, at the start of a turning therapy, the right turning bladder may be inflated. Thereafter, the left turning bladder is inflated while the right turning bladder is deflated generally simultaneously. Likewise, then the right turning bladder is inflated and the left turning bladder is deflated simultaneously. This is continued until the turning therapy is stopped at which time both bladders are deflated, such as shown in FIGS. 3 and 4.

The air pressure required to rotate the patient depends on the patient's weight, body type and various other parameters. The quantity of air pressure that rotates one patient, e.g., 30 degrees, may rotate another patient, e.g., 5 degrees. Each patient is unique and different and the control unit has to be controlled to provide the desired rotation for each patient. Typically, the turning bladders will inflate to form a ramp on one side in a range of 5 degrees to 30 degrees, more typically about 10 degrees to 20 degrees, and more commonly about 15 degrees.

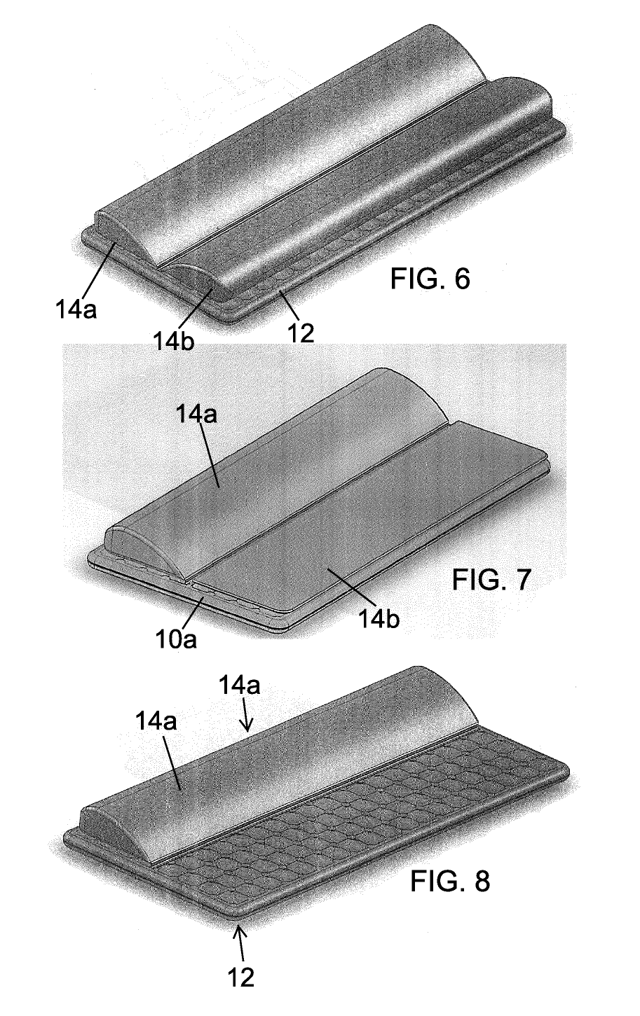

Referring to FIGS. 6 and 7, optionally, both turning bladders may be inflated to form a cradle for a patient or as noted above may be individually inflated to turn the patient. For example, as viewed in FIG. 7, the left side bladder may be inflated to turn a patient to the right as viewed from the foot end 10a of patient turner 10, while right side bladder 14b is deflated. Optionally, the air flow from one bladder may be directed to the other bladder by way of the pump (or compressor) with the excess air (when the turning therapy is complete and both bladders are deflated) being stored in a reservoir or simply discharged into the atmosphere or to the low air loss system or the bottom cushioning layer.

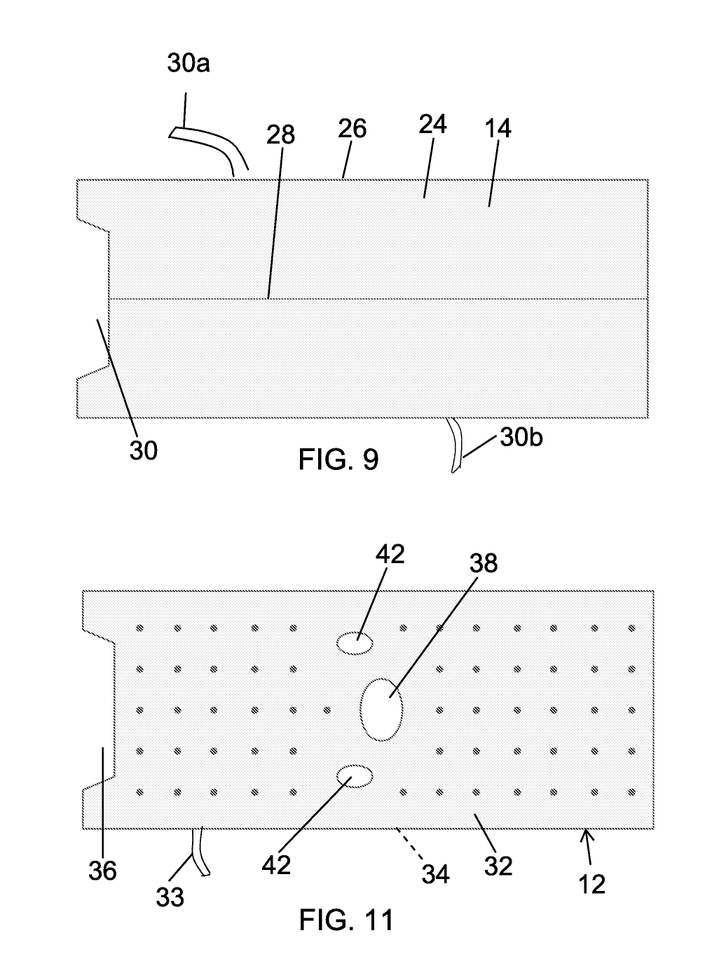

Referring to FIG. 9, as noted above, bladder 14 may be formed from two sheets of material, 24 and 26, which are formed from a non-permeable material, such as a non-permeable plastic, and are jointed by a seal at their respective perimeters and, further, as noted, by central seal 28. The seals may be formed by heat sealing, RF welding, or sonic welding. Optionally, bladder layer 14 may include a cut-out or recessed portion to form a relief 30 at its foot end, centrally located between the two opposed sides of layer 14. Relief 30 is sized to form a heel relief section so that when a patient is supported on bladder layer 14 the patient's heels will be free from contact with layer 14.

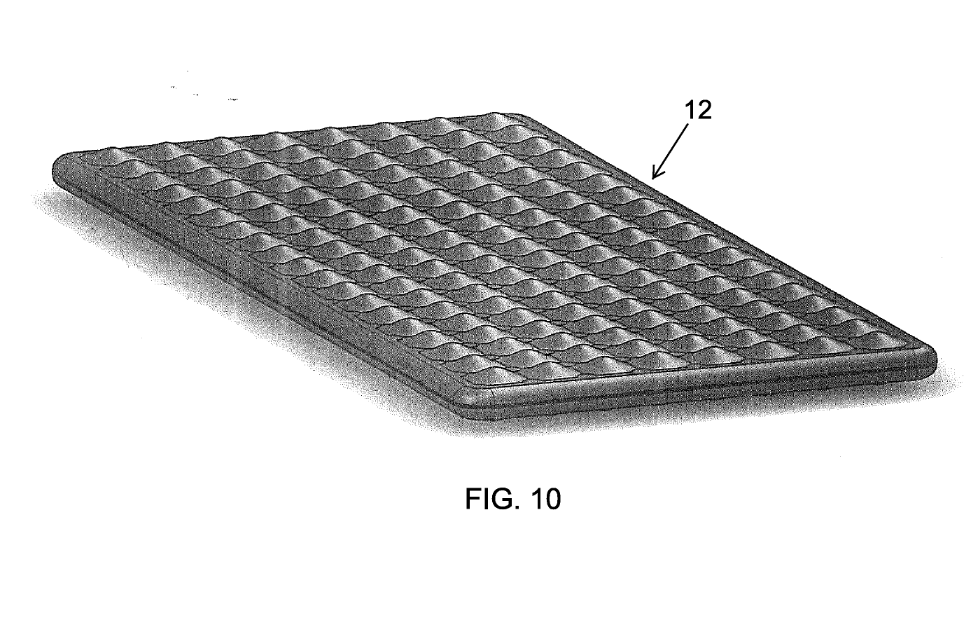

Referring to FIGS. 8, 10, and 11, base layer 12 comprises a cushioning layer, such as an inflatable cushioning layer, which supports both the turning layer 14 and in turn the top layer 16. Base layer 12 may also comprise an inflatable layer and may be formed from two or more sheets 32 and 34 of gas and liquid impermeable flexible material, such as plastic, nylon, or the like, which are sealed together at their respective perimeters to form a plenum between the two sheets, which is in selective fluid communication with the control unit described above or below by way of an inlet/outlet and a conduit 33. The sheets may then be joined together by a plurality of button or spot seals or welds to control the separation of the two sheets (to stop billowing or hot-dogging) when the plenum space between the two sheets is filled with air. The button or spot seals create a plurality of extended pockets, with the size and spacing of the pockets controlled by the spacing of the spot welds or seals, which may be uniform across the length and width of layer 12 or may be increased in some regions and decreased in other regions to form pockets of different heights. Further, in the illustrated embodiment each of the pockets is in fluid communication with each other pocket, though they can be grouped into zones to control the pressure in different regions of layer 12. For example, the pockets on the sides of the layer may be arranged to be taller than the pockets in the middle of the layer to create a cradling effect for the patient.

Referring to FIG. 11, layer 12 may also incorporate a cut out or recessed region at its foot end to form a heel relief region 36 that aligns with heel relief region 30 of intermediate layer 14 so that so that when a patient is supported on patient turner 10 the patient's heels will be suspended above the surface on which patient turner 10 is supported.

Referring again to FIG. 11, layer 12 also includes a plurality openings or recesses to provide relief to the sacral region of a patient and the trochanter regions of a patient. For example, in the illustrated embodiment, layer 12 includes an oval or elliptical opening 38 is in the central region of layer 12, which is sized to provide relief to at least a portion of the sacral region of a patient. Additional openings 40 and 42 are provided, which align with the trochanter region of the patient so that when a patient is turned, openings reduce the stress on the trochantor and allow greater immersion of the patient's trochantor without an attendant increase in pressure.

Referring to FIG. 12, 110 generally designates another embodiment of a patient turner of the present invention. As will be more fully described below, patient turner 110 is configured for positioning on top of a mattress or “patient support surface” on a bed, such as a hospital bed, long term care bed, or a home bed, and incorporates two or more turning bladders to turn the patient to assist in reducing the local pressure on a patient's skin lying on the turning surface. Further, patient turner 110 is optionally configured to provide a low air loss surface to reduce if not prevent moisture build up at the patient interface.

As best seen in FIG. 12, patient turner 110 similarly includes a base layer 112, an intermediate layer 114, and a top layer 116, which also may be configured as a low air loss surface. For further details of a suitable base layer and top layer reference is made to the first embodiment.

As note above the turning bladders may be segmented or divided to form a plurality of turning bladders. In the illustrated embodiment, intermediate layer 114 includes four or more turning bladders, namely an outer left turning bladder 114a, an inner left turning bladder 114c, an outer right turning bladder 114b, and an inner right turning bladder 114d. In the illustrated embodiment, each turning bladder 114a-d has a generally round cross-section, as compared to the wedge shaped cross-sections of bladders 14a and 14b. Bladders 114a-114d may be similar formed by two sheets sealed or welded together, with outer bladders formed by parallel seals or welds that are further apart than the seals forming inner bladder so that outer bladders have an increased diameter. Alternately, bladders 114a-114d may be separately formed and then joined or interconnected together to form a layer.

Further, while each of the conduits supplying air to the respective layers 128, 130,132, 133, is illustrated as a separate conduit, it should be understood that they each may be provided by a lumen of a multi-lumen conduit so that only a single conduit need be provided with the patient turner 110. In addition, while illustrated as connecting to the respective layers at the foot end of patient turner, the conduits may couple to the respective layers at the head end or optionally at an intermediate location. When in fluid communication with the respective layers, especially the turning bladders, at an intermediate location, the patient will be turned closer to their center of gravity, which produces a smoother turn and introduces less twisting on the patient because the head and feet tend to follow the torso turning, but the torso does not tend to follow the feet or head turning.

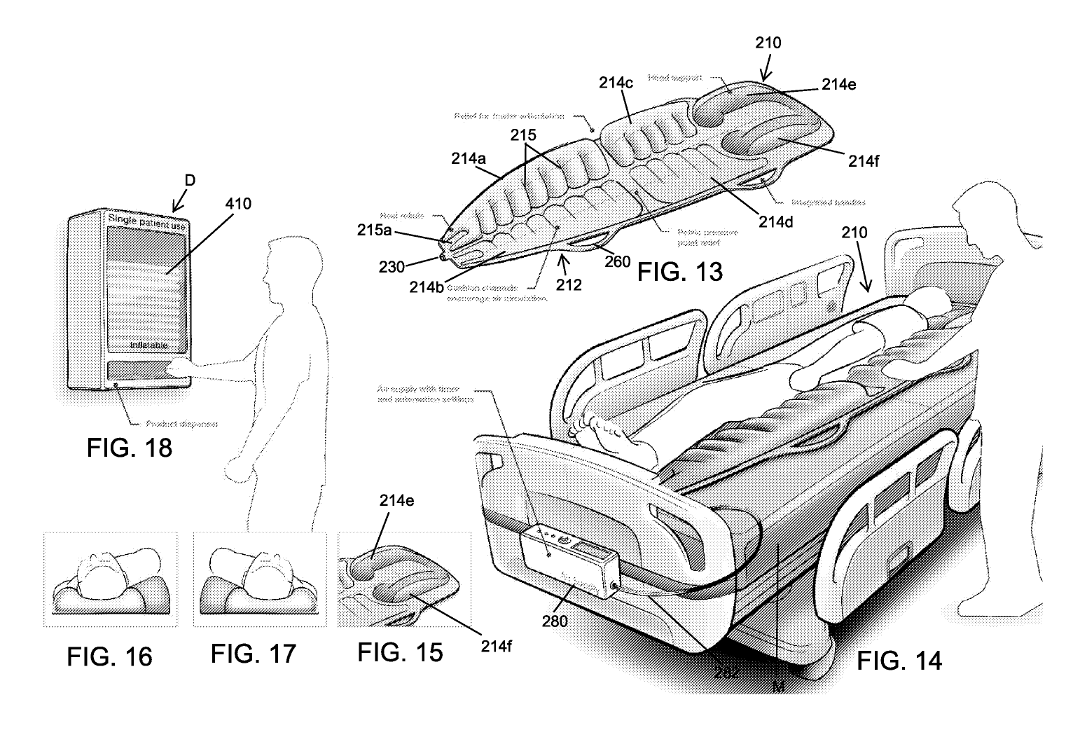

Referring to FIGS. 13-17, the numeral 210 designates yet another embodiment of a patient turner of the present invention. Patient turner 210 similarly includes a base layer 212 and a turning layer 214, which may be configured as a low air loss surface. For further details of a suitable base layer 212 reference is made to the first embodiment.

As described above the turning bladders may be segmented or divided to a plurality of turning bladders. In the illustrated embodiment, turning bladder layer 214 includes two or more turning bladders on each side, namely a left foot-end turning bladder 214a, a left seat turning bladder 214c, a right foot-end turning bladder 214b, and a right seat turning bladder 214d. In the illustrated embodiment, each turning bladder 214a-d has a generally wedge shaped cross-section, but are also segmented by lateral seals or welds 215. Seals 215 form finger-like bladder segments, which are in fluid communication with each other and tend to redistribute the pressure exerted by the turning bladders, which increases the comfort for the patient.

Bladders 214a-d may be similar formed by two sheets sealed or welded together, with the bladders formed by seals or welds that follow along the edge of the layer 214 and then turn inwardly toward the central region of the layer and then back down the central spine of the layer to form a loop, but with the additional seals that segregated each bladder to form the finger regions noted above. Optionally, the foot-end bladders may each have an inverted U-shaped seal to form heel relief regions. Alternately, the bladders may be separately formed and then joined or interconnected together or mounted to a common sheet to form layer 214.

Left and right foot-end left turning bladders 214a and 214b are spaced from left and right seat turning bladders 214c and 214d to form a pelvic relief region so that when a patient is turned the pressure on the pelvis is reduced. Additionally, but providing longitudinally divided turning bladders, the left or right bladders may be inflated/deflated sequentially to also provide wave therapy as noted above.

As noted above, turning layer 214 may be configured as a low air loss surface. For example, the upper sheet forming layer 214 may have a plurality of apertures formed therein either by stamping or by the nature of the material forming the upper sheet. For example, the upper sheet may be formed from material that has interstices that allow air to flow through the upper surface (and thereby provide the low air loss function) but which are small enough to limit liquid intrusion into layer 214. For examples of suitable materials reference is made to the patient transfer pad described in U.S. patent application entitled PATIENT TRANSFER DEVICE, Ser. No. 12/554,431, filed Sep. 4, 2009 (Attorney Docket No. STR03C P241), which is commonly assigned to Stryker Corporation of Kalamazoo, Mich. and hereby incorporated by reference in its entirety.

Layer 214 also includes head-end supports 214e and 214f, which help cradle and support the patient's head when being turned, such as shown in FIGS. 16 and 17. Head-end supports 214e and 214f may also comprise bladders but may remain inflated regardless of the inflation of bladders 214a-214d. Head-end supports 214e and 214f may also be formed from foam or gel, and further may be releasably attached to layer 214, for example by snaps, hook and loop fasteners, such as VELCRO strips, or the like. Furthermore, head-end supports 214e and 214f may be formed as a single inverted U shaped pillow, such as shown in FIGS. 13 and 15.

Referring again to FIG. 13, bottom layer 212 may also incorporate handles 260, such as integrated loops, which may further assist an attendant in turning a patient. Additionally, handles 260 may be used to shift the position of the patient on the underlying mattress M. To ease movement of the patient, bottom layer 212 may comprise or may incorporate the patient transfer pad described in U.S. patent application entitled PATIENT TRANSFER DEVICE, Ser. No. 12/554,431, filed Sep. 4, 2009 (Attorney Docket No. STR03C P241), which is commonly assigned to Stryker Corporation of Kalamazoo, Mich. and hereby incorporated by reference in its entirety.

As best seen in FIG. 14, patient turner 210 may be in fluid communication with a dedicated air supply (such as a pump or blower) and control unit 280 by way of a conduit 282 through an inlet/outlet port 230, which in the illustrated embodiment is provided at the foot end of turner 210. Conduit 282 may comprise a multi-lumen conduit, which is in fluid communication with the air supply though a manifold and which supplies air to each of the layers through port 230, which similarly includes a plurality of lumens, optionally with one or more lumens provided for each portion of the turner that needs air flow. In this manner, a single conduit can be used to supply air to each of the layers requiring air flow.

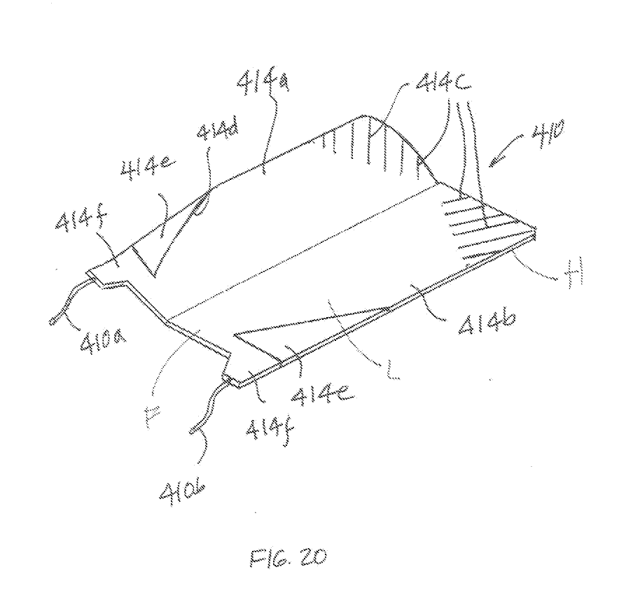

Referring to FIGS. 19 and 20, the numeral 410 generally designates another embodiment of a patient turner of the present invention. In the illustrated embodiment, patient turner 410 similarly includes a turning layer 414, which may also be configured as a low air loss surface and may also be supported on a base layer (not shown). For further details of a suitable base layer and a suitable upper layer that may be positioned below and above turning layer 414, reference is made to the above described embodiments.

Turning layer 414 may be formed from two sheets of impermeable material (or with one permeable sheet as described below) that are joined together, such as by welding, to form a bladder that may be segmented or divided to a plurality of turning bladders, for example a right side bladder and a left side bladder, and further into head-end right side and left side bladders, back or seat right side and left side bladders, and foot-end right side and left side bladders.

In the illustrated embodiment, the chambers at the head-end H of turning bladders 414a, 414b are tapered inwardly toward the central longitudinal axis of turner 410 to focus the turning force under the shoulders of a patient. For example, the head ends of each bladder may include a seal or plurality of seals 414c, as shown, which either seal off or limit the available space for inflation at the head end corners of turner 410 so that they reduce the volume of air needed to inflate each of the bladders. Alternately, bladders 414a, 414b may be formed with tapered head-ends (i.e. with the corners eliminated entirely), which would thereby also reduce the volume of the chambers and further the material needed to form the bladder layer (and also reduce the weight of the turning layer). Optionally the entire turner may have its head end corners eliminated to reduce the weight of the turner. In this manner, the amount of air flow needed to turn the patient can be reduced. This may allow the use of a smaller pump or blower.

Similarly, the chambers forming the leg sections L of bladders 414a, 414b are tapered inwardly (toward the central longitudinal axis of turner 410) similar to bladders 212a and 212b, to focus the force at the hip region of the patient and also, again, reduce the volume of air needed to turn the patient. In the illustrated embodiment, the chambers along the leg sections are tapered inwardly by a seal 414d that extends approximately from the hip location of patient to adjacent the foot location of the patient and then extends laterally outward to form a triangular shaped region that remains uninflated. Optionally, the foot ends F of the chambers resume the full width of the turning layer 414 so that the distal end (at the foot end F) of the bladders forms a widened inflated region (414f) to provide lateral support to the patient's feet and a conduit for air so that the inlet and outlets may be more easily accessible from opposed sides of the patient support. The general construction of the turning bladders. i.e. being formed from two panels or sheets of material sealed or welded together, may be similar to the earlier embodiments, such as bladders 114a, 114b, and further may be segmented into zones or regions similar to bladders 214a, 214b, 214c, 214d.

Similar to the previous embodiments, turning layer 414 may be configured as a low air loss surface. For example, the upper sheet forming layer 414 may have a plurality of apertures formed therein either by stamping or by the nature of the material forming the upper sheet. For example, the upper sheet may be formed from material that has interstices that allow air to flow through the upper surface (and thereby provide the low air loss function) but which are small enough to limit liquid intrusion into layer 414. For examples of suitable materials reference is made to the patient transfer pad described in U.S. patent application entitled PATIENT TRANSFER DEVICE, Ser. No. 12/554,431, filed Sep. 4, 2009 (Attorney Docket No. STR03C P241), which is commonly assigned to Stryker Corporation of Kalamazoo, Mich. and hereby incorporated by reference in its entirety. Also, turner 410, as noted, may have an upper layer that is configured as a low air loss component.

Patient turner 410 may also be in fluid communication with an air supply, including a dedicated air supply and control unit, by way of one or more conduits 410a, 410b through an inlet/outlet port, which may be provided at the foot end (as shown) or head end of turner 410. For example, air may be supplied by an onboard or bed based air supply as noted above. Although two conduits are shown, it should be understood that a single conduit may be used, in which case the conduit may comprise a multi-lumen conduit that is in fluid communication with the air supply though a manifold and which supplies air to each of the bladders and/or layers, for example in the case of the moisture management or low air loss upper layer. In this manner, a single conduit can be used to supply air to each of the layers requiring air flow.

Optionally the air supply and control unit may be incorporated into the turner so that the turner is a self-contained unit.

While each of the conduits 30a, 30b, 33, 128, 130,132, 133 of patient turners 10 and 110 that supply air to the respective layers is illustrated as a separate conduit, it should be understood that they may be replaced by a multi-lumen conduit, such as shown in reference to patient turner 210, so that only a single conduit need be provided with the patient turner. In addition, while illustrated as connecting to the respective layers at the foot end of patient turner, the conduits may couple to the respective layers at the head end or optionally at an intermediate location. When fluid communication is provided at an intermediate location, namely for the turning bladders, the patient will be turned closer to their center of gravity (which is typically about 3 inches below the naval), which produces a smoother turn and introduces less twisting on the patient because the head and feet tend to follow the torso when being turned, but the torso does not tend to follow the feet or head when being turned.

In each of the above reference patient turners, the fluid flowing into the low air loss layer, turning bladder layer, and/or the cushion layer may be warmed or cooled to provide temperature management of the patient's body or to warm or cool the interface with the patient's skin to further assist in reducing the risk of the development of ulcers or bed sores. As referenced above, the patient turner may have a separate dedicated control unit that controls the flow of air to the respective layers or components of the patient turner or may be connected to a bed based control and air supply system. In addition to controlling temperature, flow rate and pressure, the control unit may also be adapted to infuse scents or to deliver enriched air, such as enriched with oxygen, which could be directed to the patient's skin by way of the low air loss layer to aid in healing or simply increase the available oxygen that is inhaled by the patient.

In addition, as shown in FIG. 12, a skin microclimate layer 300, such as described in U.S. patent application entitled MICROCLIMATE MANAGEMENT SYSTEM, Ser. No. 12/899,059, filed Oct. 6, 2010 (Attorney Docket No. STR03 P268A), which is commonly assigned to Stryker Corporation of Kalamazoo, Mich. and hereby incorporated by reference in its entirety, may be used on top of any of the patient turners to further improve the moisture control at the patient skin interface and further reduce the chances of bodily fluids entering and contaminating the patient turners described herein.

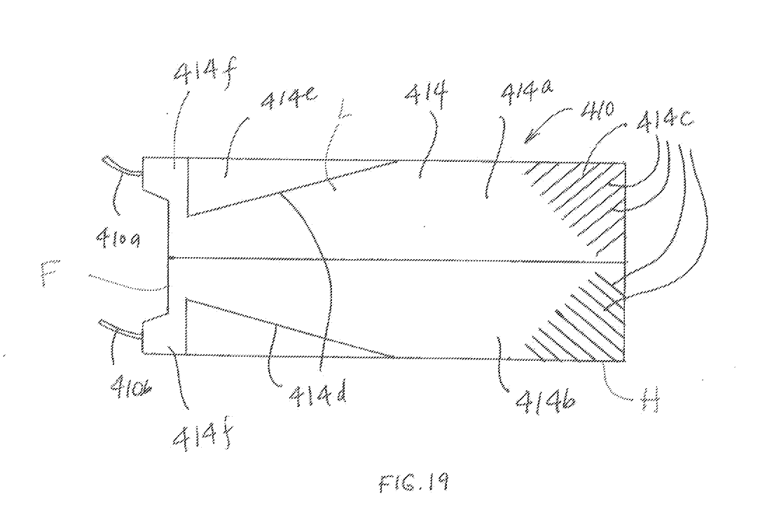

To reduce the chances of viral or bacterial transmission, any of the above patient turners may be formed with or coated with antimicrobial material, such as copper or a copper alloy, including copper powder or a copper alloy powder, such as described in U.S. Pat. Appl. entitled MEDICAL EQUIPMENT WITH ANTIMICROBIAL COMPONENTS AND/OR SYSTEM, Ser. No. 61/559,407, filed Nov. 14, 2011 (Attorney Docket No. STR03 P383), which is commonly assigned to Stryker Corporation of Kalamazoo, Mich. and hereby incorporated by reference in its entirety. Additionally, any of the above patient turners may be formed as a disposable surface. Referring to FIG. 18, each of the above patient turners may be construction so that, when fully deflated, may be folded and packaged as a unit 410 so that they can be dispensed from a dispensing unit D and used for single patient use.

While several forms of the invention have been shown and described, other changes and modifications will be appreciated by those skilled in the relevant art. Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

It should be understood that directional terms used herein, such as “vertical,” “horizontal,” “top,” “bottom,” “intermediate”, “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. For example, features of one embodiment may be combined with one or more features of another embodiment. In addition, the use of the term patient is used broadly and not intended to limited to someone under medical treatment, and instead the term patient also covers invalids and people undergoing long term care or home care.

This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which we claim an exclusive property right or privilege are defined as follows:

1. A patient turner for positioning on a mattress, the patient turner comprising:
a base layer; and
a turning bladder layer, the turning bladder layer being configured for positioning either immediately under the patient or under a non-supporting layer, which is immediately under the patient, and with the base layer supporting the turning bladder above the mattress.

2. The patient turner according to claim 1, wherein the base layer includes a relief for the sacral region of a patient.

3. The patient turner according to claim 2, wherein the base layer includes relief regions for the trochanter regions of the patient.

4. The patient turner according to claim 3, wherein the relief regions comprise transverse openings that extend through the base layer from its upper surface through to its lower surface.

5. The patient turner according to claim 4, further comprising a low air loss component.

6. The patient turner according to claim 5, wherein the low air loss component comprises a low air loss layer overlaying said turning bladder layer.

7. The patient turner according to claim 5, wherein the turning bladder layer forms said low air loss component.

8. The patient turner according to claim 1, wherein at least said turning layer is in fluid communication with an air supply.

9. A patient turner for positioning on a mattress, the patient turner comprising:
a turning bladder layer having a central longitudinal axis, said turning bladder layer including a left side bladder and a right side bladder, said left side bladder and said right side bladder left being configured for positioning under a patient or under a support surface supporting a patient, said left side bladder and said right side bladder on either side of said central longitudinal axis and each forming a chamber, and said chambers each having at least one region having a reduced cross-section to reduce the volume of said chambers at said regions.

10. The patient turner according to claim 9, wherein said left side bladder and said right side bladder each have a head end, and said regions being located adjacent said head end.

11. The patient turner according to claim 9, wherein said left side bladder and said right side bladder each have a foot end, and said regions being located adjacent said foot end.

12. The patient turner according to claim 9, wherein said left side bladder and said right side bladder are each segmented into a leg section, a seat section and a head section.

13. The patient turner according to claim 9, further comprising a base layer under said turning bladder layer.

14. The patient turner according to claim 13, wherein said base layer includes at least one region of reduced thickness or an opening to form a relief area.

15. The patient turner according to claim 9, further comprising an upper layer, said upper layer forming a part of a low air loss system.

16. The patient turner according to claim 9, wherein said turning bladder layer is formed by an upper sheet, said upper sheet comprising a permeable upper sheet to form part of a low air loss system.

17. A method of turning a patient comprising:
locating a bladder either directly under or in close proximity to one side of a patient's body without any intervening supporting layers;
directing air flow to the bladder to raise one side of the patient's body and thereby turn the patient.

18. The method according to claim 17, wherein said locating a bladder including locating a left side bladder and a right side bladder either directly under or in close proximity to the patient's body without any intervening supporting layers, and said directing air flow to the bladder includes directing air flow to one of the left side bladder and the right side bladder.

19. The method according to claim 18, wherein each of said left side bladder and said right side bladder has a chamber, and said directing air flow includes directly air flow to only a portion of the chamber of the respective bladder.

20. The method according to claim 18, further comprising directing air flow across said left side bladder and said right side bladder or from said left side bladder and said right side bladder external to said left side bladder and said right side bladder to provide a low air loss system.
